(19) United States
(12) Patent Application Publication
(10) Pub. No.: US 2008/0103004 A1
(43) Pub. Date: May 1, 2008

(54) Constant direction pointer device

(75) Inventor: Juo-Ling Chen, Taichung City (TW)

Correspondence Address: BIRCH STEWART KOLASCH & BIRCH, PO BOX 747, FALLS CHURCH, VA, 22040-0747, US

(73) Assignee: JUO-LING CHEN

(21) Appl. No.: 11/797,042

(22) Filed: Apr. 30, 2007

(30) Foreign Application Priority Data
Oct. 25, 2006 (CN) 200620149095.4

(51) Int. Cl. B62D 11/00

(52) U.S. Cl. 475/19

(57) ABSTRACT

This device consists of a car body, which further consists of a first wheel and a second wheel; a first angular compensation mechanism which further consists of a first transmission set for transmitting a first torque generated by the first wheel, a second transmission set for transmitting a second torque generated by the second wheel; a second angular compensation mechanism having a first planetary gear train which is connected to and installed at the first transmission set of the first angular compensation mechanism for receiving the first torque, a second planetary gear train which is connected to and installed at the second transmission set of the first angular compensation mechanism for receiving the second torque; and a direction pointer which is connected to and installed at the second angular compensation mechanism wherein the direction pointer is driven by the first and the second torque to generate a rotation in order to obtain a compensation angular velocity. Owing to this compensation angular velocity, the direction pointer preserves a directional constancy in any two dimensional motion of the car body.

### FIELD OF THE INVENTION

The present invention is related to a constant direction pointer device having the form of south pointing chariot, it is more specifically related to a direction positioning device which applies a composite planetary gear train and a compensation transmission mechanism in order to let the direction pointer preserve a directional constancy.

### BACKGROUND OF THE INVENTION

Here we describe the problem to be solved first: Please refer to FIG. 1, which is the top view of a two dimensional curved motion of south pointing chariot 10 along counterclockwise direction and around a center point; here we assume that the direction pointer 15 of south pointing chariot 10 is fixed on car body 11. If the car body 11 runs from the initial location at the right side, after time Δt, to the final location at the left side, then we compare the directions of south pointing chariot direction pointer 15 at these two locations, we can obviously see that direction pointer 15 has rotated certain degrees. This explains that if direction pointer 15 is fixed to the car body 11 of south pointing chariot 10 and when angular velocity (ω_{R}) at the right wheel≠ angular velocity (ω_{L}) at the left wheel, then during the two dimensional curved motion performed by south pointing chariot 10, direction pointer 15 will necessarily possess certain angular velocity. Since this angular velocity is not created artificially, it can then be called “inherent angular velocity”. If we want to let direction pointer 15 on the south pointing chariot 10 not be affected by any arbitrary two dimensional curved motion performed by car body 11 and keep a fixed direction, we must let the above-mentioned inherent angular velocity can be fully cancelled at any time. Therefore, direction pointer 15 and the car body 11 of south pointing chariot 10 can not be locked and fixed directly and some appropriate angular velocity compensation mechanisms must be added so that direction pointer 15 can obtain an appropriate compensation angular velocity and the constant direction purpose can then be achieved. Next, how to design appropriate angular velocity compensation mechanism is what we have to face.

South pointing chariot is one of the greatest inventions in ancient China and it is believed to be created by an ancient Chinese emperor about five thousand years ago. However, since it is too long ago, the original design is hardly possible to know. In 1940s, an English engineer Jeorge Lanchester, based on the version created by Su Yen of Sung Dynasty of ancient China, used a differential gear train and modern mechanical processing and assembly technology to successfully reproduce the south pointing chariot.

Please refer to FIG. 2, which shows the front view of a Lanchester south pointing chariot 20. We can see that it consists of a left wheel 21, a right wheel 22 and a direction pointer 23; meanwhile, a differential gear set 24 is used to achieve the angular compensation effect of direction pointer 23; furthermore, a first and a second bevel gear 25, 26, are installed respectively at the left and right wheel 21, 22; the bevel gear 25, 26, are then engaged respectively to a third and a fourth bevel gear 27, 28 so as to transmit a first and a second torque of the left and right wheel 21, 22 to a first and a second gear set 291, 292; then this first and second gear set 291, 292 is used to let the differential gear set 24 make rotational motion when south pointing chariot 20 is making a turn; finally, direction pointer 23 can obtain a compensation angular velocity to maintain its directional constancy, that is, it will not change its direction due to the turning of south pointing chariot 20.

The invention from ancient people is admirable, however, is the original design of south pointing chariot really like this and is it impossible that any other form or structure exists? For this question, the present invention proposes a brand new design and structure to not only reproduce the south pointing chariot successfully, but also to display another possible structure of the south pointing chariot.

### SUMMARY OF THE INVENTION

The present invention is related to a constant direction pointer device having the form of south pointing chariot, the device consists of a car body, which possesses a first and a second wheel and a first angular compensation mechanism which in turn consists of a first and a second transmission set so as to transmit respectively a first torque of the first wheel and a second torque of the second wheel, a second angular compensation mechanism which possesses a first planetary gear train and a second planetary gear train so as to receive respectively the first and the second torque, and a direction pointer which is connected rigidly to arm; the direction pointer responds to the first and the second torque to make a rotational motion and a compensation angular velocity is obtained through the rotational motion.

In a better embodiment, the device consists of a first bevel gear and a second bevel gear which are connected respectively to the first and the second wheel so as to transmit torques.

In a yet better embodiment, the device consists of a third bevel gear and a fourth bevel gear which are engaged respectively to the first and the second bevel gear so as to drive the first and the second transmission set.

In a further better embodiment, the first transmission set of the device possesses a left sprocket and an upper sprocket, and the first planetary gear train possesses an outer sun gear and a set of outer planet gears so as to form an outer planetary gear train; moreover, since the upper sprocket is connected rigidly to the outer sun gear, the upper sprocket can then let the outer sun gear rotate and the outer sun gear will let the outer planet gear set rotate.

In another better embodiment, the second transmission set of the device possesses a right sprocket and a lower sprocket, and the second planetary gear train possesses an inner sun gear and a set of inner planet gears so as to form an inner planetary gear train; moreover, since the lower sprocket is connected rigidly to the inner sun gear, the lower sprocket can then let the inner sun gear rotate and the inner sun gear can let the set of inner planet gear rotate.

In further another better embodiment, the device further consists of a set of planet shafts which is fixed and assembled respectively to each outer planet gear and each inner planet gear, the set of planet shafts are further matched to the shaft holes of an arm with residual gaps respectively, that is, the first and the second planetary gear train forms a composite planetary gear train. Therefore, the net rotational effect of the first and the second planetary gear trains will then drive the arm, meanwhile, since the arm is connected rigidly to the direction pointer, the net rotational effect is thus the compensation angular velocity obtained by the direction pointer.

From the above descriptions of the present invention, we can see that the constant direction pointer device we apply can use a first angular compensation mechanism to transmit the first and the second torque of the first and the second wheel and use a second angular compensation mechanism to receive the torques so that the direction pointer will make an appropriate rotation. In order to facilitate the descriptions, we will make a further demonstration on the present invention through the following better embodiments and drawings.

### BRIEF DESCRIPTIONS OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a planar illustration of the present invention regarding inherent angular velocity;

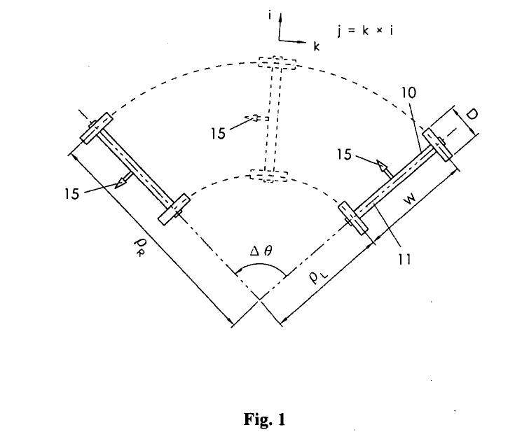

FIG. 2 is the front view illustration of the prior art south pointing chariot;

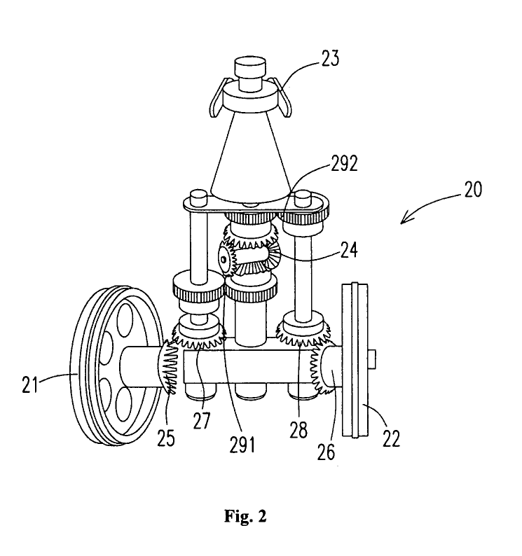

FIG. 3 is the front view illustration of a better embodiment of the present invention;

FIG. 4 is the front view illustration of the first and second angular compensation mechanisms of FIG. 3;

FIG. 5 is the exploded stereo illustration of the first and second planetary gear trains of FIG. 4;

FIG. 6 is the assembly stereo illustration of the first and second planetary gear trains of FIG. 5;

FIG. 7 is the decomposition illustration of a better embodiment of the present invention;

FIG. 8 is a stereo drawing of the constant direction pointer device having a south pointing chariot form of the present invention;

FIG. 9 is the partial decomposition illustration of another better embodiment of the present invention;

FIG. 10 is the partial decomposition illustration of further another better embodiment of the present invention; and

FIG. 11 is the partial decomposition illustration of yet another better embodiment of the present invention.

### DETAILED DESCRIPTIONS OF THE PRESENT INVENTION

In order to make features and functions of the present invention be better understood, the following embodiments accompanied with drawings will be used for the descriptions:

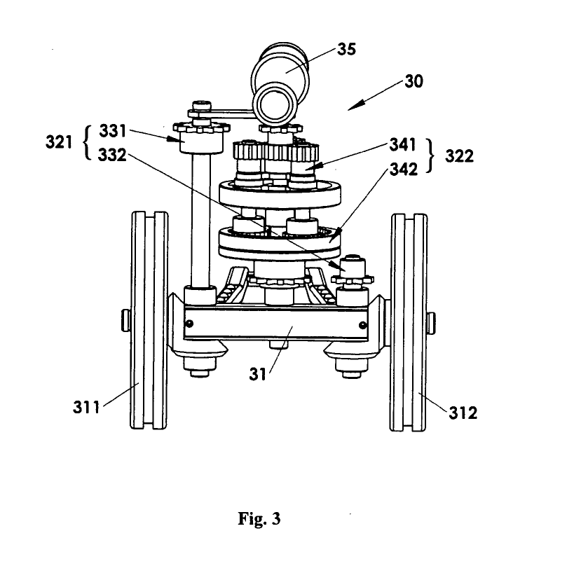

Please refer to FIG. 3 which shows that the present invention is a constant direction pointer device having the form of south pointing chariot 30. The device consists of a car body 31 having a first and a second wheel 311, 312; and a first angular compensation mechanism 321 which is installed on the car body 31 and possesses a first and a second transmission set 331, 332 to transmit respectively a first torque of a first wheel 311 and a second torque of a second wheel 312; and a second angular compensation mechanism 322 having a first planetary gear train 341 and a second planetary gear train 342 so as to receive respectively the first and the second torque; and a direction pointer 35, which responds to the first and the second torque so as to make a rotational motion and finally to obtain a compensation angular velocity through the rotational motion.

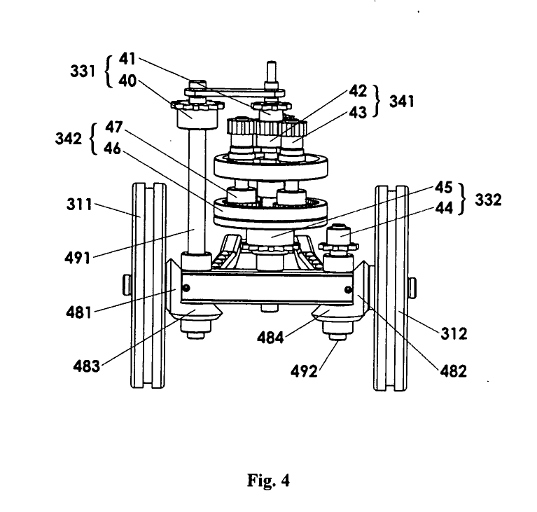

Please refer to FIG. 4, which shows that a first bevel gear 481 and a second bevel gear 482 are connected respectively to a first and a second wheel 311, 312 and transmit the first torque and the second torque; a third bevel gear 483 and a fourth bevel gear 484 are connected respectively to a first and a second bevel gear 481, 482 and drive a first and a second transmission set 331, 332 of a first angular compensation mechanism 321.

The first transmission set 331 consists of a left sprocket 40 and an upper sprocket 41 (chain is not displayed in the figure), meanwhile, the second transmission set 332 further consists of right sprocket 44 and a lower sprocket 45 (chain is not displayed in the figure).

The first planetary gear train 341 of the second angular compensation mechanism 322 possesses an outer sun gear 42 and three outer planet gears 43 to form an outer planetary gear train. However, since the upper sprocket 41 is connected rigidly to the outer sun gear 42, the upper sprocket 41 can then let the outer sun gear 42 rotate and the outer sun gear 42 can let the outer planet gears 43 rotate; moreover, the second planetary gear train 342 of the second angular compensation mechanism 322 possesses an inner sun gear 46 and three inner planet gears 47 to form an inner planetary gear train; since the lower sprocket 45 and the inner sun gear 46 are rigidly connected to each other, the lower sprocket 45 can then let the sun gear 46 rotate and the inner sun gear 46 can let the inner planet gears 47 rotate.

What needs to be emphasized here is, through the theory of kinematics of mechanism, we can prove that it is absolutely impossible to let the direction pointer obtain an appropriate compensation angular velocity relying solely on the second angular compensation mechanism 322, instead, it need the assistance of the first angular compensation mechanism 321 which has special engaging ratios. Through accurate calculations, we can obtain the correct engaging ratios of each transmission set 331, 332 of the first angular compensation mechanism 321, then refer to industrial spec, we can specify the appropriate numbers of teeth of the sprockets 40, 41, 44, 45.

Here, for the first angular compensation mechanism 321, each of the sprockets 40, 41, 44, 45 is adopted here for transmission in this invention. Other types of transmission mechanism, for example: all kinds of gear transmission, belt transmission, friction wheel transmission or worm gear/worm transmission, etc. can all achieve the same purpose.

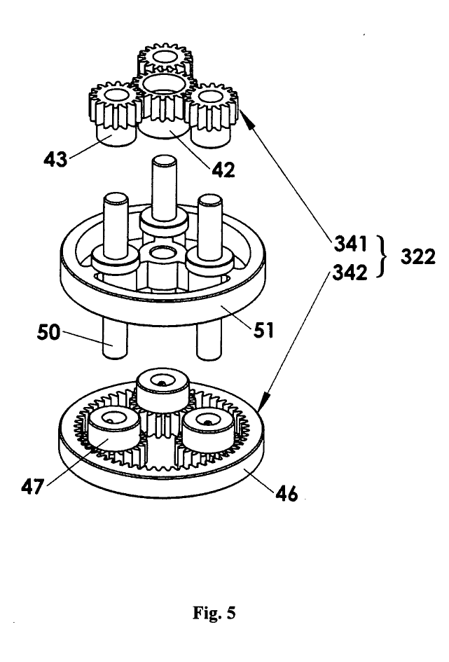

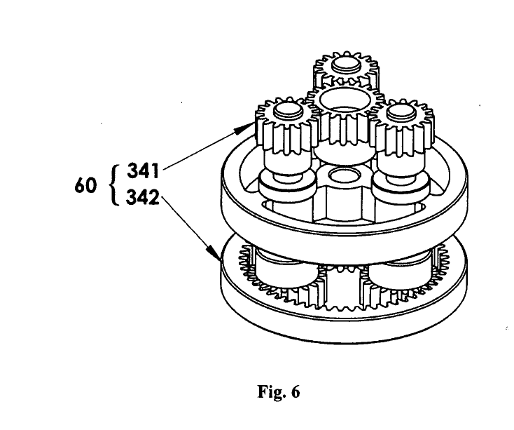

Please refer to FIG. 5, the second angular compensation mechanism 322 further consists of three planet shafts 50 which are rigidly connected to the outer planet gears 43, the planet shafts 50 further match with the holes of arm 51 with residual gaps so that the outer planet gear 43 can drive arm 51, meanwhile, the arm 51 is connected rigidly to the direction pointer 35; furthermore, the planet shafts 50 are also rigidly connected to the inner planet gears 47, so the inner planet gears 47 can drive the arm 50; in addition, the first and the second planetary gear trains 341, 342 form a composite planetary gear train 60 as shown in FIG. 6.

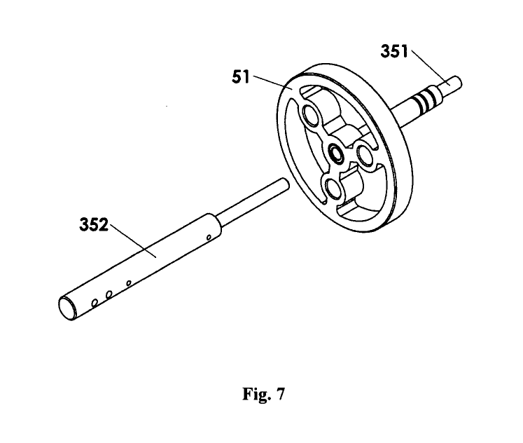

Here, as shown in FIG. 7, the pointer shaft 351 is rigidly connected to the pointer 35 and to the central hole of arm 51. The central part of pointer shaft 351 is hollowed and matches with center shaft 352 loosely. The whole set, including pointer 35, pointer shaft 351 and arm 51, can rotate freely relative to center shaft 352. The center shaft 352 is fixed to the car body 31.

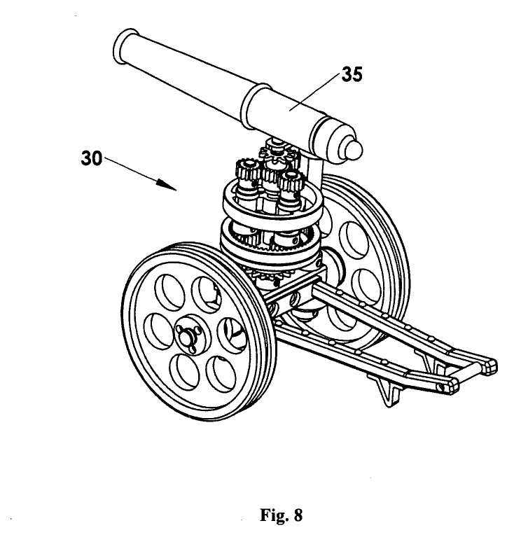

The present invention is mainly to describe a new mechanism for the south pointing chariot. Through the present invention, the direction pointer 35 will not be affected by the moving trajectory of the car body 31 and will point constantly toward certain fixed direction. The main difference between the present invention and the compass is that the present invention is based on the principles of kinematics of rigid body and the angular compensation purpose is achieved through the interactions and relative motions among the mechanical elements; therefore, the function of this invention, will not be affected by the exterior electromagnetic field at all. Moreover, the entire appearance of the mechanism of south pointing chariot 30 of the present invention is as shown in FIG. 8, wherein the direction pointer 35 is made in a shape of cannon, hence, for appearance concern, this part can be made into other shapes.

In the following, we will perform a detailed description on the mechanism and operation mechanism of the present invention. As shown in FIGS. 4 and 5, when the south pointing chariot 30 performs a two dimensional curved motion, the angular velocity (generated through the first torque) of the wheel 311 will be input through the engagement of the first bevel gear 481 with the third bevel gear 483; moreover, the rotation of the third bevel gear 483 will drive a left transmission shaft 491 which in turn will make the left sprocket 40 rotate, the left sprocket 40 will drive the upper sprocket 41 and the upper sun gear 42 through a chain (not drawn); meanwhile, the outer planet gear 43 will rotate accordingly and drive the planet shaft 50, finally, the arm 51 will rotate; in addition, the angular velocity of the second wheel 312 (generated by the second torque) will be input through the engagement of the second bevel gear 482 with the fourth bevel gear 484 and the rotation of the fourth bevel gear 484 will drive the right transmission shaft 492, which in turn will make the right sprocket 44 rotate, the right sprocket 44 will drive, through a chain (not drawn), the lower sprocket 45 to rotate and in turn the inner sun gear 46 to rotate; meanwhile, each of the inner planet gear 47 will rotate accordingly and drive each of the planet shaft 50 to rotate accordingly, finally, the arm 51 will rotate.

In addition to the above mentioned embodiment, the second angular compensation mechanism of the present invention can be changed as in the followings:

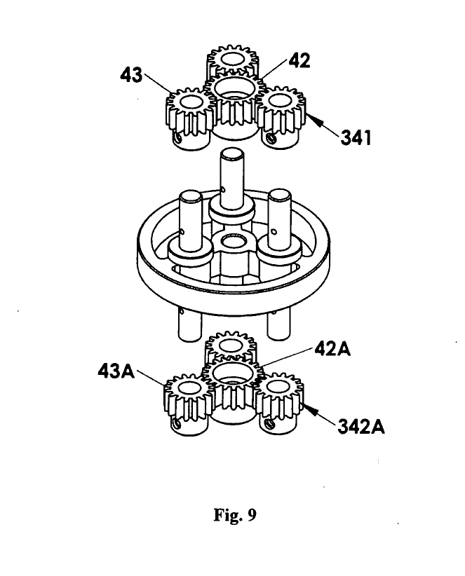

First, as shown in FIG. 9, the second angular compensation mechanism consists of a first planetary gear train 341 and a second planetary gear train 342A. Moreover, the first and second planetary gear trains 341 & 342A consist of outer sun gears 42, 42A and outer planet gears 43, 43A respectively; therefore, to provide the desired compensation angular velocity.

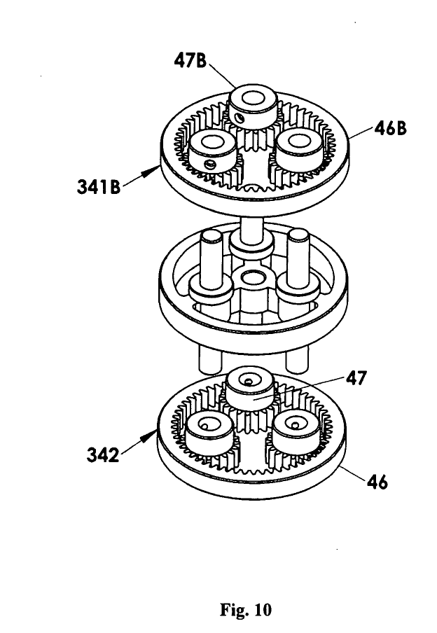

In addition, as shown in FIG. 10, the second angular compensation mechanism consists of a first planetary gear train 341B and a second planetary gear train 342. Moreover, the first and second planetary gear trains 341B & 342 consist of inner sun gears 46B, 46 and inner planet gears 47B, 47 respectively; therefore, to provide the desired compensation angular velocity.

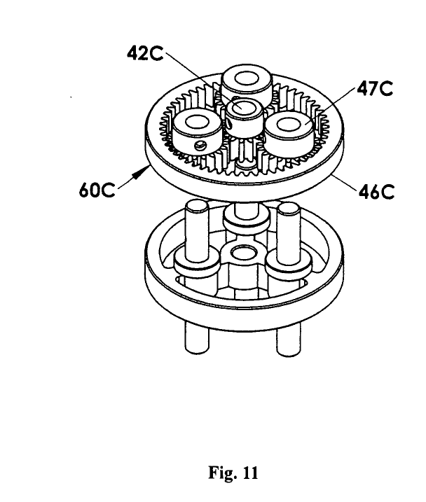

Furthermore, as shown in FIG. 11, the first and the second planetary gear trains of the second angular compensation mechanism can be merged to form a single composite planetary gear train 60C. The composite planetary gear train 60C consists of an outer sun gear 42C, an inner sun gear 46C and three planet gears 47C, and each of the planet gear 47C is engaged to the outer sun gear 42C and the inner sun gear 46C at the same time; therefore, the desired compensation angular velocity is provided.

To summarize the above descriptions, we know that the angular velocity of arm 51 is actually a mathematical function of the angular velocity of the first wheel 311 and the angular velocity of the second wheel 312 as independent variables; when direction pointer 35 and the arm 51 are rigidly connected in an appropriate way (as descriptions of FIG. 7 as mentioned above), then the compensation angular velocity of the direction pointer 35 can be decided by the angular velocity of the first wheel 311 and the angular velocity of the second wheel 312. Moreover, through theoretical analysis and calculations, we can then take appropriate design parameters to let the compensation angular velocity of the direction pointer 35 can just cancel the inherent angular velocity mentioned above, and finally, the direction pointer 35 can keep a constant direction. We know that this invention does provide a new design. Through the use of the first angular compensation mechanism, the first and the second torques of the first and the second wheels can be transmitted, meanwhile, the applied second angular compensation mechanism can receive these torques to let the direction pointer make a rotation in order to achieve the purpose of preserving a directional constancy. Therefore, anyone who is familiar with this art can make equivalent modifications without deviating the spirit of what is claimed.

1. A constant direction pointer device of the form of south pointing chariot comprising of:
a car body having a first and a second wheel;
a first angular compensation mechanism having a first transmission set to transmit a first torque generated by the first wheel and a second transmission set to transmit the second torque generated by the second wheel;
a second angular compensation mechanism having a first planetary gear train which is installed at the first transmission set of the first angular compensation mechanism in order to receive a first torque and a second planetary gear train which is installed at the second transmission set of the first angular compensation mechanism in order to receive the second torque; and
a direction pointer which is connected to the second angular compensation mechanism and the direction pointer is driven by the first and the second torque to generate a rotational motion and in turn to obtain a compensation angular velocity.

2. The constant direction pointer device of the form of south pointing chariot as of claim 1 wherein the first planetary gear train consists of an outer sun gear and a set of outer planet gear to form an outer planetary gear train, meanwhile, the outer sun gear makes the outer planet gear set rotate.

3. The constant direction pointer device of the form of south pointing chariot as of claim 1 wherein the first planetary gear train consists of an inner sun gear and a set of inner planet gear so as to form an inner planetary gear train, meanwhile, the inner sun gear makes the inner planet gear set rotate.

4. The constant direction pointer device of the form of south pointing chariot as of claim 1 wherein the second planetary gear train consists of an outer sun gear and a set of outer planet gear so as to form an outer planetary gear train, meanwhile the outer sun gear makes the outer planet gear rotate.

5. The constant direction pointer device of the form of south pointing chariot as of claim 1 wherein the second planetary gear train consists of an inner sun gear and a set of inner planet gear so as to form an inner planetary gear train; meanwhile, the inner sun gear makes the inner planet gear rotate.

6. The constant direction pointer device of the form of south pointing chariot as of claim 1 wherein it further consists of a set of planet shafts to be rigidly connected to the planet gears of the first planetary gear train and the second planetary gear train; moreover, the planet shafts are further matched to the shaft holes of an arm with residual gaps so that the planet gear sets of the first planetary gear train and the second planetary gear train can drive the arm, and in the mean time, the arm is rigidly connected to the direction pointer.

7. The constant direction pointer device of the form of south pointing chariot as of claim 1 wherein the first planetary gear train and the second planetary gear train form a composite planetary gear train.

8. The constant direction pointer device of the form of south pointing chariot as of claim 1 wherein a center shaft rotates and pivots to the arm.

9. The constant direction pointer device of the form of south pointing chariot as of claim 1 wherein the first transmission set and the second transmission set of the first angular compensation mechanism can include all kinds of transmitting mechanisms such as gears, worm gear/worm, frictionwheel, belt/belt wheel or chain/sprocket.
